(19) United States
(12) Patent Application Publication
(10) Pub. No.: US 2004/0118376 A1
(43) Pub. Date: Jun. 24, 2004

(54) Control apparatus for internal combustion engine having adapting function to aging

(75) Inventor: Hisayo Dohta, Chiryu-city (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Aichi-pref. (JP)

(21) Appl. No.: 10/733,389

(22) Filed: Dec. 12, 2003

(30) Foreign Application Priority Data
Dec. 12, 2002 (JP) 2002-360384

(51) Int. Cl. F02D 41/08; F02D 41/14

(52) U.S. Cl. 123/339.18; 123/694

(57) ABSTRACT

A response time constant of an A/F ratio control system is calculated in accordance with an engine operating condition. A control gain is calculated based on the response time constant. A degradation index of a response of an A/F sensor is calculated, so as to be used as a parameter representing a model error or aging degree of the A/F control system. The control gain is corrected with a correction coefficient corresponding to the model error. An A/F feedback correcting amount is calculated using the response time constant, the control gain and a deviation between a detected A/F and a target A/F, so as to decrease the deviation. Thus, the A/F control system is prevented from a degradation caused by aging.

### CROSS REFERENCE TO RELATED APPLICATION

This application is based on Japanese Patent Application No. 2002-360384 filed on Dec. 12, 2002 the disclosure of which is incorporated herein by reference.

### BACKGROUND OF THE INVENTION

The present invention is related to a control apparatus for controlling an internal combustion engine in accordance with an aging of a specific control system of the internal combustion engine.

Recently, an internal combustion engine for a vehicle includes a catalyst and an air/fuel ratio sensor. The catalyst, such as a three-way catalyst, is provided in an exhaust pipe for purifying exhaust gas. The air/fuel ratio sensor (A/F sensor) detects O2 concentration of exhaust gas for indirectly measuring an air/fuel ratio of air-fuel mixture. A fuel injection amount of the fuel injector is controlled, so that an air/fuel ratio detected by the A/F sensor coincides with a target air/fuel ratio for the most efficient purification of the exhaust gas. An air/fuel ratio control model (A/F control model) is used for controlling the fuel injection amount (i.e., air/fuel ratio) in an air/fuel control system. The A/F control model simulates a control object defined from the fuel injector to the A/F sensor.

In general, a response time constant of the A/F control model is varied in accordance with a variation of an engine operating condition. Mainly, response of the A/F sensor varies in accordance with a variation of the engine operating condition Q, especially air intake amount. The response of the A/F sensor is a dominant factor of the response time constant of the A/F control model. However, conventional A/F control model does not take into account the variation of the response time constant depending on the variation of the operation condition of the engine. Accordingly, a control gain in the air/fuel control system is set small over the entire operation range for securing stability of the A/F control. As a result, performance of the A/F control system becomes low with respect to the variation of the engine operating condition.

An A/F controller proposed in U.S. Pat. No. 6,397,830 (JP-A-2001-90584) changes response time constant of the A/F control model in accordance with the engine operating condition, so as to change a control gain corresponding to the response time constant of the A/F control model. Thus, a characteristic of the A/F control model is changed in accordance with the engine operating condition, so that response of the A/F control is enhanced with respect to the variation of the engine operating condition, while a stability of the A/F control is secured over the entire operating range.

However, a characteristic of an A/F control system varies due to its aging, such as aging of response of an A/F sensor. Accordingly, proper gain of the A/F control needed for securing stability and response varies corresponding to the variation of the characteristic of the control system. Here, the A/F control system in the related art does not take into account the aging of the A/F control system. The above A/F control system sets the same control gain while the engine operating condition is not varied, even the characteristic of the A/F control system is varied due to the aging of the control system. Accordingly, the A/F control system cannot control the air/fuel ratio using a proper control gain, so that stability and response cannot be secured.

### SUMMARY OF THE INVENTION

In view of the foregoing problems, it is an object of the present invention to propose a control apparatus, which can set a proper control gain in accordance with an aging degree of a control system of an internal combustion engine, so that controllability, such as stability and response, can be maintained against aging.

In the present invention, a control apparatus for an internal combustion engine includes a control system, an aging detecting unit, and a control gain changing unit. The control system controls the internal combustion engine. The aging detecting unit calculates an aging degree of the control system. The control gain changing unit changes a control gain of the control system in accordance with the aging degree. Even if the characteristic of the control system is changed due to its aging, the control gain can be changed in accordance with the change of the characteristic of the control system. Thus, controllability, such as stability and response, can be maintained against aging.

### BRIEF DESCRIPTION OF THE DRAWINGS

Other objects, features and advantages of the present invention will become more apparent from the following detailed description made with reference to the accompanying drawings, in which:

FIG. 1 is a schematic overview showing an engine control system according to the first embodiment of the present invention;

FIG. 2 is a flowchart showing an air/fuel ratio feedback correction amount calculating program executed in the first embodiment;

FIG. 3 is a flowchart showing a model error calculating program (1) executed in the first embodiment;

FIG. 4 is a flowchart showing a model error calculating program (2) executed in the first embodiment;

FIG. 5 is a flowchart showing an air/fuel ratio feedback correction amount calculating program executed in the second embodiment of the present invention;

FIG. 6 is a schematic data map (relationship between a control gain and an operating condition) in a variation of both the first embodiment and the second embodiment in the present invention;

FIG. 7 is a flowchart showing a control gain changing program executed in the third embodiment of the present invention;

FIG. 8 is a time chart showing a relationship between an electrical load condition and a change of engine rotation speed in the third embodiment; and

FIG. 9 is a time chart showing an effect of the third embodiment.

### DETAILED DESCRIPTION OF THE PREFERRED EMBODIMENTS

[First Embodiment]

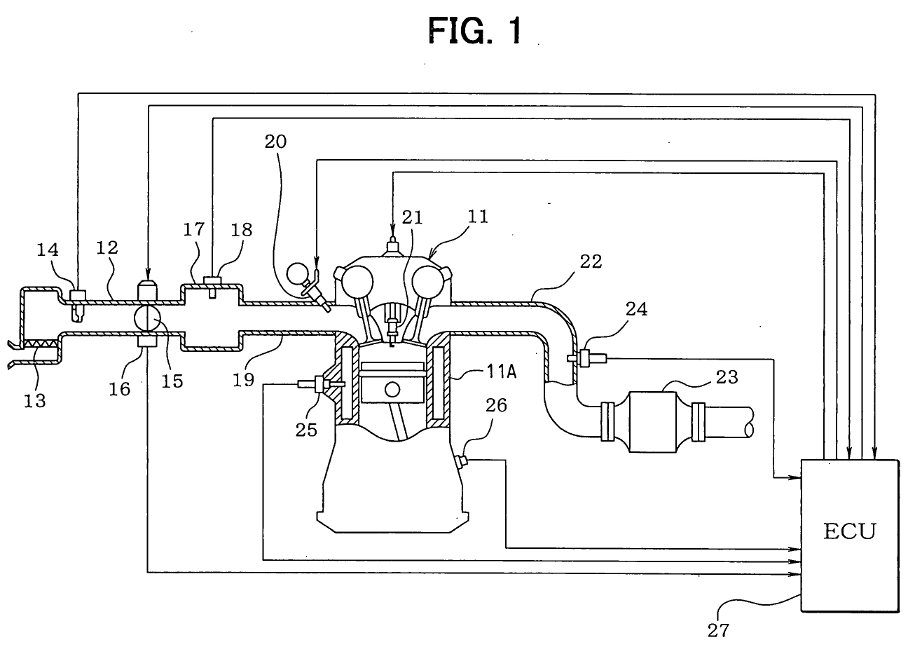

As shown in FIG. 1, an air cleaner 13 is provided on the uppermost side of an air stream in an intake pipe 12 of an internal combustion engine 11. An air flow meter 14 is provided in the downstream of the air cleaner 13 for detecting air flow amount. A throttle valve 15 and a throttle opening sensor 16 are provided in the downstream of the air flow meter 14. The throttle valve 15 is controlled by a D.C. motor or the like. The throttle opening sensor 16 detects the opening degree of the throttle valve 15. The throttle valve 15 is used as a control valve of an air intake flow so as to control air intake amount in a both normal operation (non-idling) and idling operation.

A surge tank 17 is provided in the downstream of the throttle valve 15. A pressure sensor 18 is provided in the surge tank 17 for detecting pressure of the intake air. An intake manifold 19 is provided on the downstream side of the surge tank 17 for introducing air toward cylinders of the engine 11 individually. A fuel injector 20 is provided in the air intake manifold 19 in the vicinity of each air intake port of the corresponding cylinder for injecting fuel. An ignition plug 21 is provided for each cylinder head of the engine 11. Mixture gas is introduced into each cylinder and ignited by spark generated by each plug.

On the other hand, a three-way catalyst 23 is provided in an exhaust pipe 22 of the engine 11 for purifying emission gas, such as CO, HC, NOx contained in exhaust gas. An air/fuel ratio sensor (A/F sensor) 24 is provided as an air/fuel ratio detecting unit on the upstream side of the catalyst 23 for detecting air/fuel ratio (A/F) in exhaust gas. A temperature sensor 25 is provided in the cylinder block 11A of the engine 11 for detecting cooling water temperature. A crank angle sensor (rotation speed detecting unit) 26 is provided in the cylinder block 11A for transmitting pulse signals which are generated with respect to each rotation of certain crank angle (30° CA, for example) of the engine 11. Crank angle and rotation speed of the engine 11 are detected based on output signals of the crank angle sensor 26.

The output signals of the various sensors are transmitted to an engine control unit (or electronic control unit, ECU) 27. The ECU 27 is mainly constructed with a microcomputer. The ECU 27 executes various kinds of engine control programs, so as to control a fuel injection amount of the injector 20 and ignition timing of the ignition plug 21 in accordance with an operation condition of the engine 11. The engine control programs are stored in a ROM (storage media) in the ECU 27.

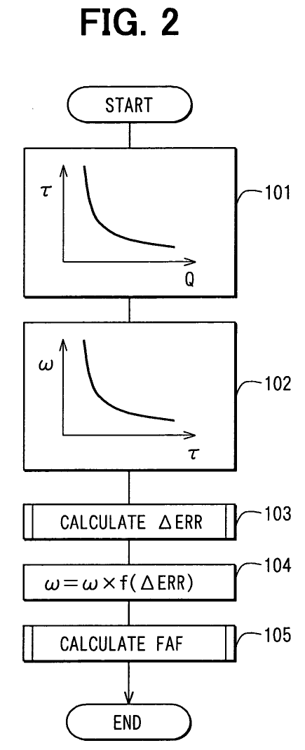

The ECU 27 executes various programs for feedback (F/B) control as shown in FIGS. 2 to 4. The ECU 27 calculates air/fuel ratio feedback correcting amount (A/F correcting amount) FAF using an air/fuel ratio control model (A/F control model), which simulates a control object defining a system from the injector 20 to the A/F sensor 24. The ECU 27 calculates the A/F correcting amount FAF using a predetermined control gain ω, so that air/fuel ratio (detection A/F) λs of exhaust gas detected by the A/F sensor 24 coincides with a target air/fuel ratio (target A/F) λtg.

In general, an A/F control model is constructed based on a premise, in which a characteristic of an A/F control system is maintained in a condition immediately after the manufacturing of a control apparatus. If the characteristic of the A/F control system varies due to aging, an error (displacement) arises in the A/F control model. Therefore, the error of the A/F control model becomes a parameter showing an aging degree of the A/F control system.

The ECU 27 executes various programs shown in FIGS. 2 to 4 for calculating the A/F correcting amount FAF while calculating an A/F control model error ΔERR caused by the aging of the A/F control system. The ECU 27 changes a control gain ω of the A/F feedback control based on the A/F control model error ΔERR, so as to set a proper control gain W corresponding to the aging degree of the A/F control system.

In this first embodiment, a degradation index of the response of the A/F sensor 24 is calculated, so as to be used as the A/F control model error ΔERR. The response (i.e., degradation degree) of the A/F sensor 24 is a dominant factor of the characteristic of the A/F control system. Therefore, the degradation index of the response of the A/F sensor 24 (A/F sensor response degradation index) accurately reflects the aging degree. Thus, the A/F sensor response degradation index is set as the model error ΔERR, so that the model error ΔERR accurately reflects aging degree of the A/F control system.

An A/F feedback correcting amount calculating program shown in FIG. 2 is executed in every fuel injection timing of the engine 11, for example. A response time constant τ corresponding to a present engine operating condition (air intake amount Q, for example) is calculated in step 101, using either a data map or an equation of the response time constant τ of the A/F control model. The data map and the equation are predetermined by an experiment, a simulation, or the like, and stored in the ROM of the ECU 27.

The routine proceeds to step 102, in which the control gain ω corresponding to the response time constant τ of the A/F control model is calculated, using either a data map or an equation of the control gain ω. The data map and the equation are predetermined by an experiment, a simulation, or the like, and stored in the ROM in the ECU 27.

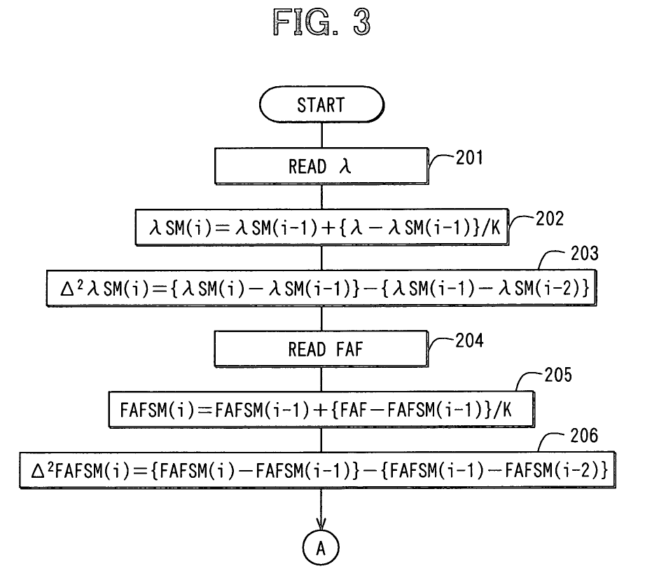

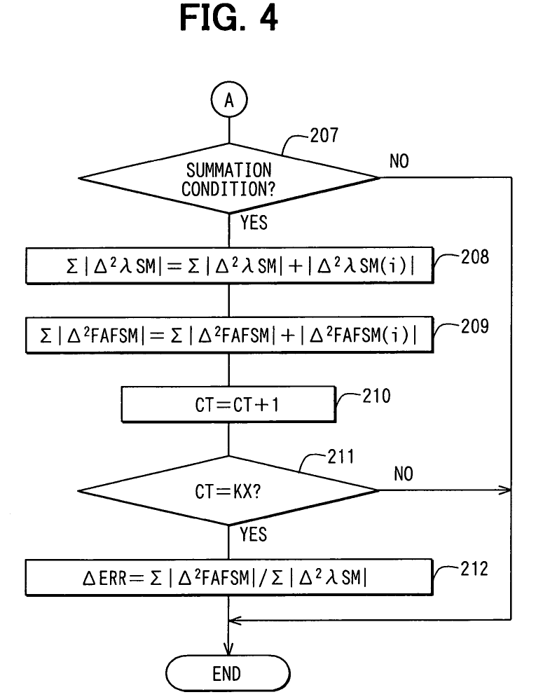

Subsequently, the routine proceeds to step 103, in which the model error ΔERR is calculated by executing model error calculating programs shown in FIG. 3 and FIG. 4. Here, the model error ΔERR is a parameter representing the aging degree of the A/F control system. Subsequently, the routine proceeds to step 104, in which a correction coefficient f(ΔERR) corresponding to the model error ΔERR is calculated using a data map or an equation. The control gain ω is multiplied with the correction coefficient f(ΔERR), so that the control gain ω is corrected to be a final control gain ω.

ω=ω×f(ΔERR)

In general, as the control gain ω of the A/F feedback control is decreased, stability of the A/F feedback control is increased. Accordingly, the data map or the equation of the correction coefficient f(ΔERR) is predetermined, such that the correction coefficient f(ΔERR) becomes small as the model error ΔERR becomes large. Namely, the control gain ω becomes small as the aging degree of the A/F control system becomes large. Step 104 is operated as a control gain changing unit.

Subsequently, the routine proceeds to step 105, in which the A/F correcting amount FAF is calculated using an equation obtained from the A/F control model, such that the detection A/F λs coincides with the target A/F λtg. In this calculating, the A/F correcting amount FAF is calculated using the response time constant τ of the A/F control system, the control gain ω, a damping factor ξ, a deviation Δλ between the detection A/F λs and the target A/F λtg, and the like. Here, a related art in U.S. Pat. No. 6,397,830 (JP-A-2001-90584) describes in detail a method for calculating the A/F correcting amount FAF using the A/F control model, for example.

On the other hand, a model error calculating program shown in FIGS. 3 and 4 is executed in step 103 in FIG. 2, so as to be operated as an aging detecting unit. The model error calculating program calculates the model error ΔERR as a parameter representing aging degree of the A/F control system as shown in FIG. 3. The signal of the detection A/F λ is converted from an analog signal to a digital signal, and stored in step 201. The signal of the detection A/F λ is filtered, so as to be conditioned for removing effects of a cylinder-to-cylinder variation in step 202, so that a final detection A/F λSM(i) is calculated.

λSM(i)=λSM(i−1)+{λ−λSM(i−1)}/k

Here, λSM(i) is a present detection A/F, λSM(i−1) is a previous detection A/F, and k is a conditioning coefficient.

Subsequently, the routine proceeds to step 203, in which a secondary differential value of the detection A/F (secondary differential A/F) Δ²λSM(i) is calculated by the following equation.

Δ²λSM(i)={λSM(i)−λSM(i−1)}−{λSM(i−1)−λSM(i−2)}

Subsequently, the A/F correcting amount FAF is read in step 204. The routine proceeds to step 205, in which the A/F correcting amount FAF is filtered by the following equation so that a final A/F correcting amount FAFSM(i) is calculated.

FAFSM(i)=FAFSM(i−1)+{FAF−FAFSM(i−1)}/k

Here, FAFSM(i) is a present A/F correcting amount, FAFSM(i−1) is a previous A/F correcting amount, and k is a conditioning coefficient.

Subsequently, the routine proceeds to step 206, in which a secondary differential value of the A/F correcting amount (secondary differential A/F correcting amount) Δ²FAFSM(i) is calculated by the following equation.

Δ²FAFSM(i)={FAFSM(i)−FAFSM(i−1)}−{FAFSM(i−1)−FAFSM(i−2)}

Subsequently, the routine proceeds to step 207 shown in FIG. 4. A condition is determined in step 207, such that whether an execution condition of both a summation of the secondary differential A/F Δ²λSM(i) and a summation of the secondary differential A/F correcting amount Δ²FAFSM(i) are valid or not. The execution condition of the summation is to satisfy the following three conditions, for example.

1. The engine 11 is completely warmed up. For example, cooling water temperature is higher than a predetermined temperature.

2. The operation is in a predetermined condition, such that, the engine rotation speed NE, the speed of the vehicle, and the pressure of the intake pipe 12 are respectively in a predetermined range.

3. The operation is not in a rapid acceleration or a rapid deceleration. For example, the variation amount of the pressure of the intake pipe 12 is less than a predetermined amount.

If the above three conditions are satisfied, the execution condition of the summation is met. However, if at least one of the above three conditions are not satisfied, the execution condition of the summation results in failure, so that this program is terminated.

On the other hand, if the relation makes a positive determination in step 207, the routine proceeds to step 208. Absolute value of the secondary differential A/F |Δ²λSM(i)| is calculated, so as to be added to a summation of the absolute value of the secondary differential A/F (summation secondary differential A/F) Σ|Δ²λSM|, so that the summation secondary differential A/F Σ|Δ²λSM| is replaced in step 208.

Σ⊕Δ²λSM|=Σ|Δ²λSM|+|Δ²λSM(i)|

Subsequently, the routine proceeds to step 209. Absolute value of the secondary differential A/F correcting amount |Δ²FAFSM(i)| is calculated, so as to be added to a summation of the absolute value of the secondary differential A/F correcting amount (summation secondary differential A/F correcting amount) Σ⊕Δ²FAFSM|, so that the summation secondary differential A/F correcting amount Σ|ΔA²FAFSM| is replaced in step 209.

Σ|Δ²FAFSM|=Σ|Δ²FAFSM|+|Δ²FAFSM(i)|

Subsequently, the routine proceeds to step 210, in which a summation time counter CT is increased in increments of 1. The routine proceeds to step 211, in which a relation is determined such that whether the summation time counter CT is increased up to a summation completion time KX. If the relation makes a negative determination in step S211, this program is terminated.

If the summation time counter CT is increased up to the summation completion time KX, the routine proceeds to step 212. The summation secondary differential A/F correcting amount Σ|Δ²FAFSM| is divided by the summation secondary differential A/F Σ|Δ²λSM|, so that the A/F sensor response degradation index is calculated, so as to be used as the model error ΔERR.

ΔERR=Σ⊕Δ²FAFSM|/Σ|Δ²λSM|

In this first embodiment, the control gain ω is changed in accordance with the model error ΔERR which represents the aging degree of the A/F control system. Accordingly, proper control gain ω can be set corresponding to the aging degree of the control system, so that both stability and response of the A/F control can be prevented from degradation caused by aging.

In this first embodiment, the A/F sensor response degradation index is used as the model error ΔERR which represents the aging degree. Because response of the A/F sensor 24 (i.e., degradation degree) is a dominant factor for the characteristic of the A/F control system. Therefore, the calculated model error ΔERR can accurately reflect aging degree of the control system.

Furthermore, the control gain ω is predetermined in this first embodiment, such that the control gain ω decreases as the model error ΔERR increases. Here, the model error ΔERR represents the aging degree of the A/F control system. Therefore, the control gain ω is set to be small when the aging degree of the A/F control system is large, so that stability of the A/F feedback control can be secured.

[Second Embodiment]

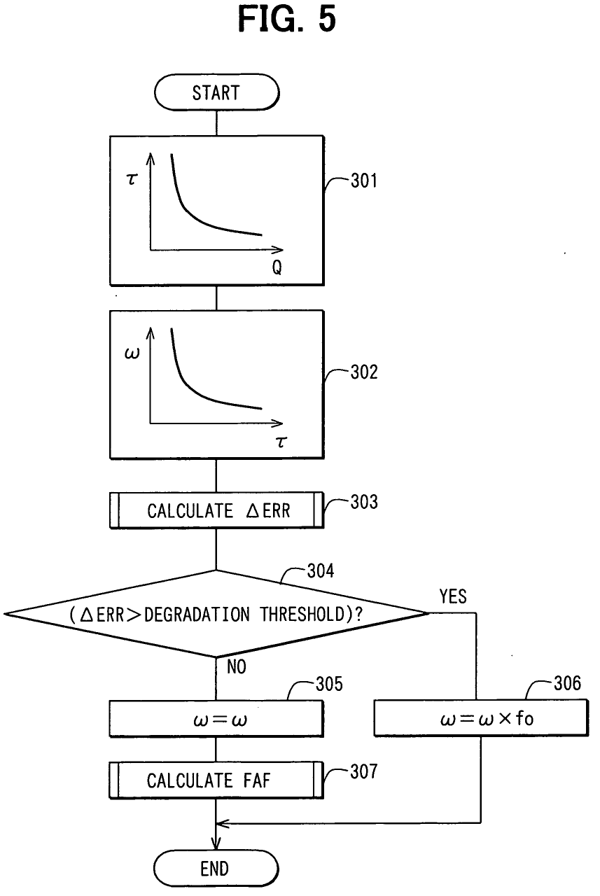

The second embodiment in the present invention is described with reference to FIG. 5. An A/F feedback correction amount calculating program is executed in the second embodiment. The control gain ω is corrected so as to be set smaller than a regular value (value in a normal condition), when the model error ΔERR is determined to be greater than a predetermined degradation threshold. Here, if the model error ΔERR is a large value, the response of the A/F sensor 24 is considered to have been degraded.

As shown in step 301, the response time constant τ is calculated in accordance with a present engine operating condition (such as air intake amount Q), using either a data map or an equation of the response time constant τ of the A/F control model. The routine proceeds to step 302, in which the control gain ω is calculated in accordance with the response time constant τ of the A/F control model, using either a data map or an equation of the control gain ω.

Subsequently, the routine proceeds to step 303, in which the model error ΔERR is calculated by executing model error calculating programs shown in FIG. 3 and FIG. 4. The model error calculating program shown in FIGS. 3 and 4 operates as an aging detecting unit.

Here, the model error ΔERR is a parameter representing aging degree of the A/F control system (i.e., an A/F sensor response degradation index). Subsequently, the routine proceeds to step 304, in which a relation is determined, such that whether the model error ΔERR is greater than a predetermined degradation threshold. Namely, A/F sensor response degradation index is determined in step 304.

If the model error ΔERR is determined to be less than the predetermined degradation threshold, i.e., the response of the A/F sensor 24 is not degraded, the aging degree of the A/F control system is determined to be small. Subsequently, the routine proceeds to step 305, in which the control gain ω corresponding to the response time constant τ is adopted without change. Here, the response time constant τ corresponds to the engine operating condition Q.

On the other hand, if the model error ΔERR is determined to be greater than the predetermined degradation threshold in step 304, i.e., the response of the A/F sensor 24 is degraded, the aging degree of the A/F control system is determined to be large. Subsequently, the routine proceeds to step 306, in which the control gain ω is multiplied by a correction coefficient f0 (0<f0<1). Here, the control gain ω is corrected, so as to be set smaller than the regular value.

ω=ω×f0

Step 306 operates as a control gain changing unit.

After setting the control gain ω either in step 305 or step 306, the routine proceeds to step 307, in which the A/F correcting amount FAF is calculated, such that the detection A/F λs coincides with the target A/F λtg using an equation obtained from the A/F control model. In this calculation, the A/F correcting amount FAF is calculated using the response time constant τ of the A/F control system, the control gain ω, a damping factor ξ, deviation AX between the detection A/F λs and the target A/F λg, and the like.

In this embodiment, the control gain ω is switched to a value, which is smaller than a regular value, when the model error ΔERR is greater than the predetermined degradation threshold. Here, the model error ΔERR represents the aging degree of the A/F control system. Therefore, the control gain ω is set small when the aging degree of the A/F control system is large, so that stability of the A/F feedback control can be secured.

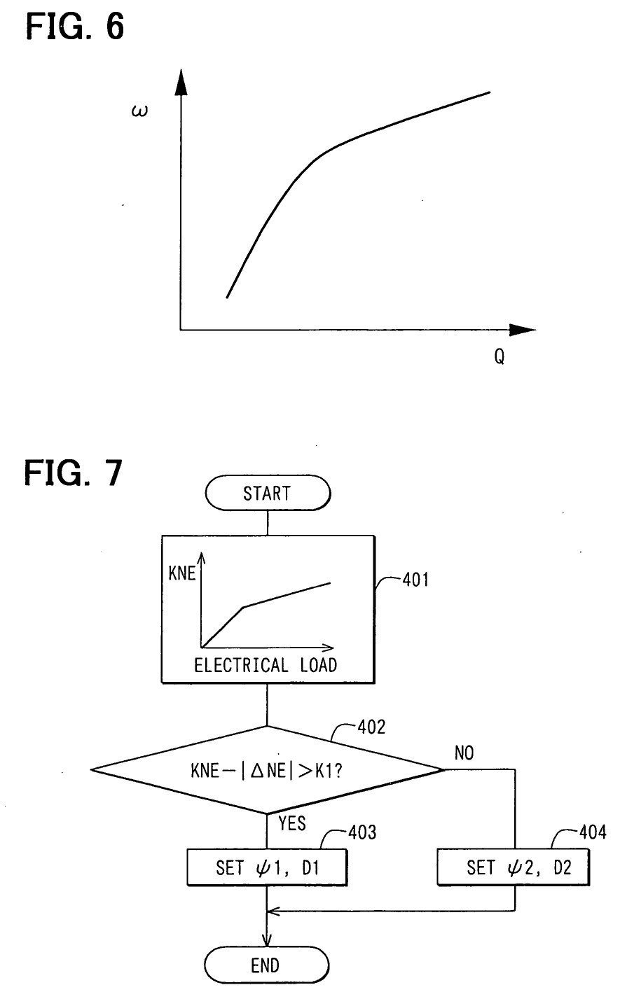

Here, the control gain ω can be directly calculated in accordance with the engine operating condition (such as air intake amount Q). In this case, as shown in FIG. 6, the control gain ω is defined using either a data map or an equation with the engine operating condition (such as air intake amount Q) as a parameter.

Besides, the present invention can be applied to an A/F control system, in which a fuel injection amount of the injector 20 is controlled so that the air/fuel ratio of the exhaust gas coincides to the target air/fuel ratio. Here, the air/fuel ratio is detected by the A/F sensor 24.

In this case, response of the A/F sensor 24 is calculated, so as to be used as a parameter representing the aging degree of the A/F control system. The control gain ω of the A/F control system is changed based on the response of the A/F sensor 24. Thus, the control gain ω can be properly set in accordance with the response of the A/F sensor 24, so that control stability and response can be prevented from degradation caused by aging.

The parameter, which represents the aging degree of the A/F control system, can be suitably changed in the operation. The parameter can be calculated using at least one of an aging degree of a component of the control apparatus and a change reflecting the aging degree of the A/F control system. Here, the component is such as the A/F sensor 24 and the injector 20. The aging degree of a component is a dominant factor for the characteristic of the A/F control system.

[Third Embodiment]

The third embodiment is described with reference to FIGS. 7 to 9. The ECU 27 executes an idle rotation speed F/B control program (not shown) in an idle rotation speed control system, so as to control the opening degree of the throttle valve 15. An idle rotation speed F/B correcting amount in an idle rotation speed F/B control is calculated for calculating the throttle opening degree of the throttle valve 15 in idling using a predetermined control gain ψ. Thus, the opening degree of the throttle valve 15 is controlled in accordance with the calculated opening degree in idling, so that the engine rotation speed NE coincides with a target idle rotation speed. Here, the engine rotation speed NE is detected by the crank angle sensor 26.

Furthermore, the ECU 27 controls a dashpot control program (not shown) in a dashpot control system. Here, the dashpot control system has a dumping function for the control motion of the throttle valve 15. The dashpot control system moderates positioning motion of the throttle valve 15. The dumping characteristic can be varied by changing the control gain ψ. The throttle valve 15 is controlled at an opening degree larger than an opening degree in idling, when the engine operation is switched from non-idling to idling. Accordingly, undershoot of the engine rotation speed NE is not apt to be caused. Namely, the engine rotation speed NE is not apt to overshoot beyond the target idle speed, from a positive position with respect to the target idle rotation speed toward a negative position with respect to the target idle rotation speed.

Here, the throttle opening in idling is multiplied by a dashpot control amount D, so that the throttle opening degree of the throttle valve 15 is calculated in the dashpot control operation. The throttle opening in idling may be an initial opening degree, for example.

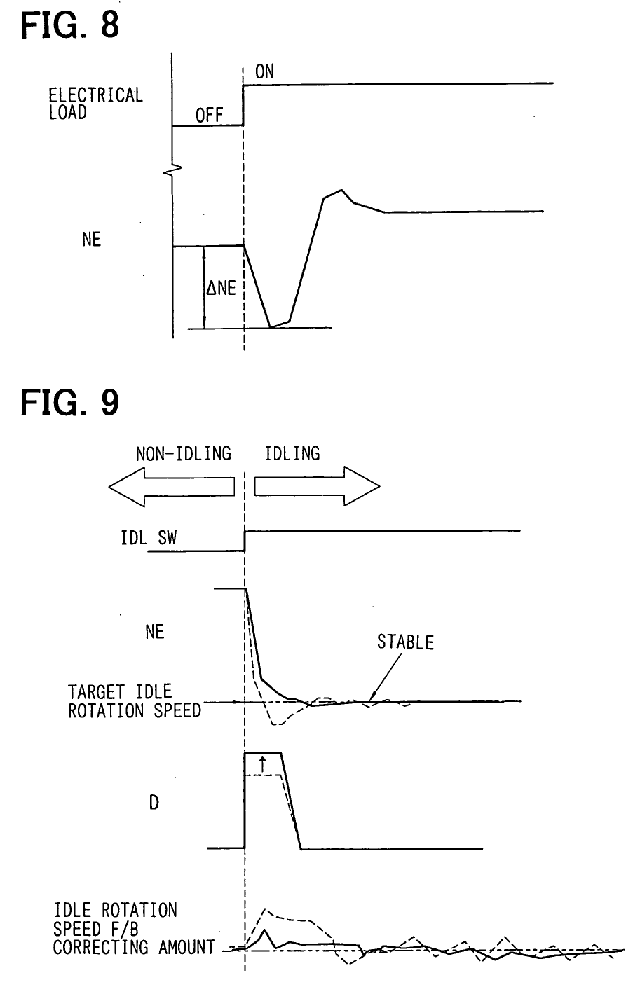

The characteristic of both the idle rotation speed control system and the dashpot control system are varied due to its aging, such as a variation of the air intake amount and a variation of engine friction. The air intake amount is mainly varied due to a deposit of debris around the throttle valve 15. Besides, the engine rotation speed NE falls by a specific amount ΔNE when an electric load is turned on (FIG. 8). The electric load is such as a head lamp. The amount of fall of the engine rotation speed ΔNE (engine rotation fall ΔNE) varies corresponding to the aging degree of both the idle rotation speed control system and the dashpot control system. Therefore, the engine rotation fall ΔNE can be used as a parameter representing the aging degree of both the idle rotation speed control system and the dashpot control system.

As shown in FIG. 7, a control gain changing program (gain changing program) is executed in the third embodiment. Both the control gain ψ for the idle rotation speed F/B control and the dashpot control amount D for the dashpot control are changed corresponding to the engine rotation fall ΔNE, when the electric load is turned on. Here, the dashpot control amount D corresponds to a control gain in the dashpot control.

The gain changing program is executed in every certain period, after the ignition switch (not shown) is turned on, for example. A threshold for determination of the engine rotation fall KNE (fall threshold KNE) is calculated in accordance with a quantity of the electric load, using either a data map or an equation of the fall threshold KNE in step 401. The data map and the equation of the fall threshold KNE are predetermined using a simulation or the like, and stored in the ROM in the ECU 27.

Subsequently, the routine proceeds to step 402, in which a relation is determined. The relation is whether a value, which is the fall threshold KNE minus the absolute value of the engine rotation fall ΔNE when an electric load is turned on, is greater than a predetermined value K1. Step 401 and step 402 operate as an aging detecting unit.

If the value is determined to be greater than the predetermined value K1 (i.e., KNE−|ΔNE|>K1), the engine rotation fall ΔNE is less than the fall threshold KNE. Therefore, the aging degree of the idle rotation control system and/or the aging degree of the dashpot control system is determined to be small, so that the routine proceeds to step 403. The control gain ψ is set to a regular control gain ψ1, and the dashpot control amount D is set to a regular dashpot control amount D1 in step 403.

On the other hand, If the value |ΔNE| is determined to be equal to or smaller than the predetermined value K1, i.e., KNE−|ΔNE|≦K1, the engine rotation fall ΔNE is in the vicinity of the fall threshold KNE or greater than the fall threshold KNE. Therefore, the aging degree of the idle rotation control system and the aging degree of the dashpot control system is determined to be large, so that the routine proceeds to step 404. The control gain ψ is set to a control gain ψ2 which is smaller than the regular control gain ψ1, in step 404. Besides, the dashpot control amount D is set to a dashpot control amount D2 which is larger than the regular dashpot control amount D1, in step 404. Namely, the control gain ψ2 and the dashpot control amount D2 are used when the aging degree is large. The control gain ψ2 and the dashpot control amount D2 may be either fixed values or set in accordance with the engine rotation fall ΔNE. Here, step 404 operates as a control gain changing unit.

As shown in FIG. 9, conventionally, if the aging degree of either the idle rotation speed control system or the dashpot control system becomes large, the engine rotation speed NE falls in a large amount when the operation is switched from non-idling to idling. Accordingly, the engine rotation speed NE overshoots the target idle rotation speed toward a negative position with respect to the target idle rotation speed, so that convergence of the engine rotation speed NE is degraded with respect to the target idle rotation speed.

On the contrary, in this third embodiment, the control gain ψ and the dashpot control amount D are changed when the engine rotation fall ΔNE is large, so that the control gain ψ and the dashpot control amount D can be properly set in accordance with the aging degree. Here, the engine rotation fall ΔNE represents the aging degree of both the idle rotation speed control system and the dashpot control system.

As shown in FIG. 9, the controllability of the idle rotation speed can be prevented from degradation caused by aging. The engine rotation speed NE can be quickly converged to the target idle rotation speed without being affected by aging.

The control gain ψ is set smaller than that in a regular condition, and the dashpot control amount D is set larger than that in a regular condition, when the aging degree is large, in the third embodiment. Here, the aging degree is equivalent to the engine rotation fall ΔNE when the electrical load is turned on.

The dashpot control amount D is set to a large amount, so that deviation between the detection rotation speed NE and the target rotation speed can be decreased after the operation is changed from non-idling to idling. The idle rotation speed control follows the dashpot control. Manipulating amount of the idle rotation speed control becomes small, because the deviation is decreased by operation of the dashpot control, so that convergence characteristic of the idle rotation speed control is enhanced. Additionally, the control gain ψ is set to a small amount, so that the stability of the idle rotation speed control can be secured. Thus, the stability (convergence) of the idle rotation speed control can be further enhanced.

The control gain ω for the A/F control system, the control gain ψ for the idle rotation control system, and the dashpot control amount D may be serially adjusted at various amounts in accordance with the aging degree. Namely, the control gain ω may be continuously degreased as the aging degree of the A/F control system increases. The control gain ψ may be continuously degreased as the engine rotation fall ΔNE increases. The dashpot control amount D may be continuously increased as the engine rotation fall ΔNE increases.

The present invention can be applied to an idle rotation speed control system which has an idle speed control valve provided in a bypass passage. The bypass passage bypasses the throttle valve 15 for controlling the air intake amount in idling.

The parameter representing the aging degree of both the idle rotation speed control system and the dashpot control system can be switched from multiple parameters during the control operation.

The parameter can be calculated using the aging degree of a mechanism, which affects the characteristic of either the idle rotation speed control system or the dashpot control system.

The parameter can be calculated using at least one change representing the aging degree of the mechanism such as a fall degree of the engine rotation speed when the electrical load is turned on, a rate of change of the engine rotation speed when the electrical load is turned on, and a variation amount of the engine rotation speed in a certain period after the electrical load is turned on.

Other various changes and modifications are to be understood as being within the scope of the present invention as defined by the appended claims.

What is claimed is:

1. A control apparatus for an internal combustion engine, the control apparatus comprising:
a control system for controlling the internal combustion engine;
an aging detecting unit for calculating an aging degree of the control system; and
a control gain changing unit for changing a control gain of the control system in accordance with the aging degree.

2. A control apparatus according to claim 1, wherein
the control system includes:
a fuel injector for injecting fuel to the internal combustion engine; and
an air/fuel ratio detecting unit provided in a downstream of the fuel injector with respect to an air intake flow for detecting air/fuel ratio of exhaust gas, and
the control system is an air/fuel ratio control system which controls a fuel injection amount of the fuel injector in accordance with a simulated control object defined from the injector to the air/fuel ratio detecting unit, so that the air/fuel ratio detected by the air/fuel ratio detecting unit coincides with a target air/fuel ratio;
the aging detecting unit calculates an error of the simulated control object as a parameter representing an aging degree of the air/fuel ratio control system, such that the error of the air/fuel ratio model arises by aging of the air/fuel ratio control system; and
the control gain changing unit changes the control gain of the air/fuel ratio control system in accordance with the error of the simulated control object.

3. A control apparatus according to claim 2, wherein the aging detecting unit calculates the error of the simulated control object in accordance with at least a response of the air/fuel ratio detecting unit.

4. A control apparatus according to claim 1, wherein
the control system includes:
a fuel injector for injecting fuel to the internal combustion engine; and
an air/fuel ratio detecting unit provided in a downstream of the fuel injector with respect to an air intake flow for detecting air/fuel ratio of exhaust gas, and
the control system is an air/fuel ratio control system which controls a fuel injection amount of the fuel injector, so that air/fuel ratio detected by the air/fuel ratio detecting unit coincides with a target air/fuel ratio;
the aging detecting unit calculates a response of the air/fuel ratio detecting unit as a parameter representing an aging degree of the air/fuel ratio control system; and
the control gain changing unit changes a control gain of the air/fuel ratio control system in accordance with the response of the air/fuel ratio detecting unit.

5. A control apparatus according to claim 1, wherein
the control system further includes:
a rotation speed detecting unit provided in the internal combustion engine for detecting rotation speed of the internal combustion engine; and
a control valve for controlling an air intake amount introduced to the internal combustion engine, and
the control system is an idle rotation control system which controls an opening degree of the control valve, so that the rotation speed detected by the rotation speed detecting unit coincides with a target idle rotation speed;
the aging detecting unit calculates a change of the rotation speed when an electrical load is turned on, for using the change as a parameter representing an aging degree of the idle rotation speed control system;
the control gain changing unit changes a control gain of the idle rotation speed control system in accordance with the change of the rotation speed when the electrical load is turned on.

6. A control apparatus according to claim 1, wherein
the control gain changing unit decreases the control gain as the aging degree increases.

7. A control apparatus according to claim 1, wherein
the control system includes:
a rotation speed detecting unit provided in the internal combustion engine for detecting rotation speed of the internal combustion engine; and
a control valve for controlling an air intake amount introduced to the internal combustion engine, and
the control system is a dashpot control system which controls an opening degree of the control valve at an opening degree larger than an opening degree in idling, when operation is changed from non-idling to idling;
the aging detecting unit calculates a change of the rotation speed when an electrical load is turned on, for using the change as a parameter representing an aging degree of the dashpot control system;
the control gain changing unit changes a control gain of the dashpot control system in accordance with the change of the rotation speed when en electrical load is turned on.

8. A control apparatus according to claim 7, wherein
the control gain changing unit increases the control gain as the aging degree increases.
